(19) United States
(12) Patent Application Publication
(10) Pub. No.: US 2025/0390336 A1
(43) Pub. Date: Dec. 25, 2025

(54) METHODS AND SYSTEMS TO VERIFY ENTITY STATE-QUANTITY VALUES FOR ASYNCHRONOUS OPERATIONS

(71) Applicant: Stripe, Inc., South San Francisco, CA (US)

(72) Inventors: Anish Sukumaran, Newcastle, WA (US); Colin Arenz, Woodinville, WA (US); Akanksha Jain, San Mateo, CA (US); Matthew Jeffryes, Moscow, ID (US)

(21) Appl. No.: 18/750,799

(22) Filed: Jun. 21, 2024

(51) Int. Cl. G06F 9/48

(52) U.S. Cl. CPC G06F 9/485

(57) ABSTRACT

Disclosed herein are methods and system for improved entity state-quantity value verification for asynchronous operations. In one example, a request for an asynchronous operation corresponding to an entity object may be identified. The entity object may include a set of state-quantity values and each state-quantity value may include a quantity associated with a possible stage in a lifecycle of the corresponding entity. A proposed state-quantity value may be determined based on the request for the asynchronous operation corresponding to the entity object. Additionally, an available state-quantity value may be generated based on at least a portion of the set of state-quantity values of the entity object. The asynchronous operation may be performed when a condition based on the proposed state-quantity value and the available state-quantity value is satisfied.

### FIELD OF DISCLOSURE

This disclosure is related generally to asynchronous operations and more particularly to techniques to verify entity state-quantity values for asynchronous operations.

### BACKGROUND

In computer programming, asynchronous operation means that a process operates independently of other processes, whereas synchronous operation means that the process runs only as a result of some other process being completed or handed off. Asynchronous operations are a non-blocking architecture that allows multiple operations to run concurrently without waiting for other tasks to complete. For example, asynchronous operations execute a sequence of operations out of time coincidence with any event. In another example, an asynchronous operation can be an operation that occurs without a regular or predictable time relationship to a specified event, such as the calling of an error diagnostic routine that may receive control at any time during the execution of a computer program. In computer programming, asynchronous operations can be beneficial for code structured as a dependency tree, where various parts of the code interleave instead of blocking each other. However, asynchronous operations can create challenges, such as when multiple asynchronous operations attempt to modify a value or state at the same, or substantially the same, time.

### BRIEF SUMMARY

Processes, apparatuses, machines, and articles of manufacture for verify entity state-quantity values for asynchronous operations are described. It will be appreciated that the embodiments may be combined in any number of ways without departing from the scope of this disclosure.

Example methods, such as computer-implemented methods for verifying state-quantity values for asynchronous operations are described herein. An example method may include identifying a request for an asynchronous operation corresponding to an entity object, the entity object including a set of state-quantity values, and each state-quantity value including a quantity associated with a possible stage in a lifecycle of a corresponding entity; determining a proposed state-quantity value based on the request for the asynchronous operation corresponding to the entity object; generating an available state-quantity value based on at least a portion of the set of state-quantity values of the entity object; and performing the asynchronous operation when a condition based on the proposed state-quantity value and the available state-quantity value is satisfied.

Example non-transitory computer-readable media are disclosed herein. An example non-transitory computer-readable storage medium includes instructions that, when executed by a processor, cause the processor to perform operations for generating transaction processing rules, the operations comprising: identifying a request for an asynchronous operation corresponding to an entity object, the entity object including a set of state-quantity values, and each state-quantity value including a quantity associated with a possible stage in a lifecycle of a corresponding entity; determining a proposed state-quantity value based on the request for the asynchronous operation corresponding to the entity object; generating an available state-quantity value based on at least a portion of the set of state-quantity values of the entity object; and performing the asynchronous operation when a condition based on the proposed state-quantity value and the available state-quantity value is satisfied.

Example server computer systems are disclosed herein. An example server computer system for generating transaction processing rules comprises a memory and a processor coupled to the memory configured to: identify a request for an asynchronous operation corresponding to an entity object, the entity object including a set of state-quantity values, and each state-quantity value including a quantity associated with a possible stage in a lifecycle of a corresponding entity; determine a proposed state-quantity value based on the request for the asynchronous operation corresponding to the entity object; generate an available state-quantity value based on at least a portion of the set of state-quantity values of the entity object; and perform the asynchronous operation when a condition based on the proposed state-quantity value and the available state-quantity value is satisfied.

Performing asynchronous operations in this manner allows for reliable, scalable, customizable, and efficient verification of state-quantity values. Other processes, machines, and articles of manufacture are also described herein, which may be combined in any number of ways, such as with the embodiments of the brief summary, without departing from the scope of this disclosure.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

To easily identify the discussion of any particular element or act, the most significant digit or digits in a reference number refer to the figure number in which that element is first introduced.

FIG. 1 illustrates a block diagram of an exemplary system architecture for verifying entity state-quantity values for asynchronous operations according to some embodiments of the present disclosure.

FIG. 2 illustrates an exemplary operating environment for an entity state unifier according to some embodiments of the present disclosure.

FIG. 3 illustrates various aspects of an entity record set data structure according to some embodiments of the present disclosure.

FIG. 4 illustrates various aspects of an entity lifecycle according to some embodiments of the present disclosure.

FIG. 5 illustrates an exemplary process flow for a state-quantity validator according to some embodiments of the present disclosure.

FIGS. 6A and 6B illustrate an exemplary process flow for an entity object according to some embodiments of the present disclosure.

FIG. 7 illustrates a logic flow of an exemplary method for verifying entity state-quantity values for an asynchronous operation according to some embodiments of the present disclosure.

FIG. 8 illustrates a computer system that may be used to support the systems and operations discussed herein according to some embodiments of the present disclosure.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “identifying”, “determining”, “generating”, “controlling”, “populating”, “updating”, “canceling”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Generally, this disclosure describes techniques for verifying state-quantity values for asynchronous operations. More specifically, embodiments are directed to a server system for implementing an entity state unifier that controls performance of, or performs, an asynchronous operation associated with an entity based on verification of state-quantity values in an entity object corresponding to the entity. In many embodiments, the asynchronous operations seek to modify a state and/or quantity associated with an entity and the entity state unifier may determine whether to allow performance of the asynchronous operation by verifying that the modification will not violate conditions for the state-quantity values associated with the entity. For example, the entity state unifier may prevent performance of asynchronous operations that would cause an available quantity to become negative, such as by allowing a proposed return amount to exceed the available quantity. In some embodiments, performing the asynchronous operation may include communicating a request, such as to authorize or clear a quantity. In several embodiments, each state-quantity value in an entity object corresponds to a stage in the lifecycle of an entity associated with the entity object. These and other embodiments are described and claimed.

Existing techniques for verifying state-quantity values are inefficient, convoluted, unreliable, and error prone. For example, several asynchronous operations from several different components may be requested during the lifecycle of an entity, and existing systems may rely on each of the different components to verify state-quantity values without a reliable source of truth or uniform enforcement mechanism. Further, with different components performing state-quantity value verifications, it can be difficult or impossible to determine the cause of and/or solution to problems with state-quantity value verifications. Additionally, challenges result when multiple asynchronous operations attempt to modify a value, such as a state-quantity value, at the same, or substantially the same, time. For example, race conditions can result when multiple asynchronous operations to modify state-quantity values are simultaneously requested and/or performed.

Adding further complexity, modifying, adding, and/or removing components or operations can result in unintended effects. For example, if a first component depends on a second component to determine a current state-quantity value for an entity and the second component is replaced with a third component, the first component may no longer be able to determine the current state-quantity value for the entity, resulting in unpredictable behavior and/or failure of the first component. These limitations can drastically reduce the reliability and adaptability of state-quantity value verifications, contributing to systems that are ineffective, error prone, and unpredictable resulting in unreliable systems, devices, and techniques with limited capabilities.

Accordingly, many embodiments disclosed herein provide resource-efficient, reliable, and scalable techniques to verify state-quantity values. In several embodiments, an entity state unifier may be utilized to verify proposed state-quantity values based on available state-quantity values from an entity object that provides a trusted source for state-quantity values associated with an entity, such as a workflow having a lifecycle of stages. Performance of operations of the workflow may cause an entity object to be created and, subsequently, modified based on the lifecycle of stages and corresponding quantities. For example, the entity state unifier may identify requests from requestors for asynchronous operations and efficiently control performance of the asynchronous operations corresponding to an entity by verifying associated with state-quantity values of an entity object in a uniform, scalable, and reliable manner.

In these and other ways, components/techniques described herein provide many technical advantages. For instance, the computer-based techniques of the current disclosure increase the accessibility, reliability, adaptability, and availability of state-quantity verification for entities, thereby improving the functioning of server systems as compared to conventional approaches. Additionally, the computer-based techniques of the current disclosure can provide users with a valuable tool for preventing processing errors resulting from performance of conflicting or erroneous operations. Further, systems function more efficiently with fewer processing errors and reduced remedial actions. Accordingly, embodiments disclosed herein can be practically utilized to improve the functioning of a computer and/or to improve a variety of technical fields including asynchronous operations, data visibility, platform systems, subscriber systems, and/or user experiences.

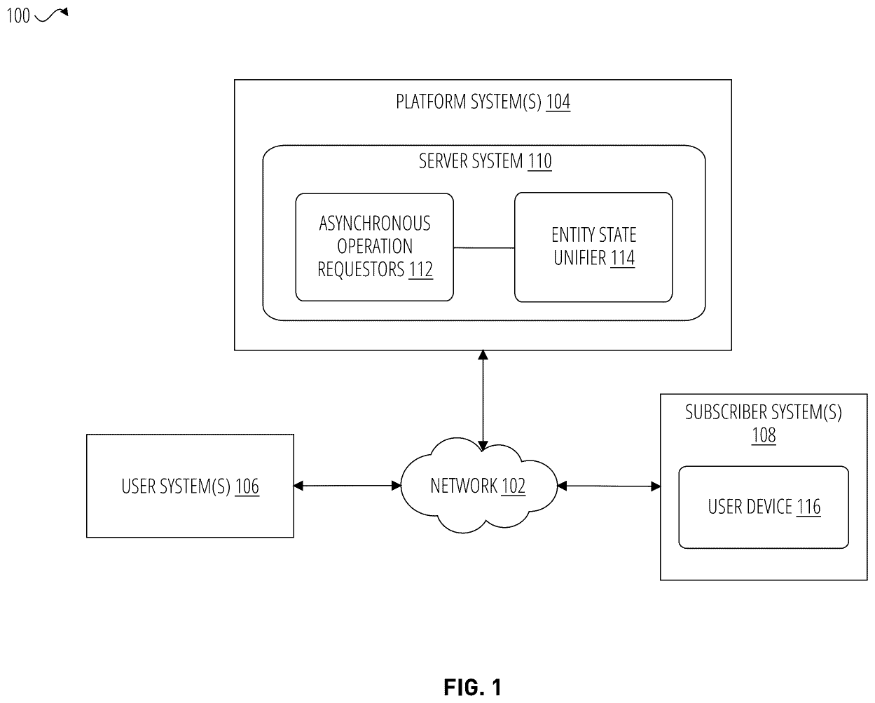

FIG. 1 is a block diagram of an exemplary system architecture 100 for verifying entity state-quantity values for asynchronous operations according to some embodiments. In one embodiment, the system 100 includes one or more platform systems 104, one or more subscriber systems 108, and one or more user systems 106. In one embodiment, one or more systems (e.g., systems 106 and 108) may be mobile computing devices, such as a smartphone, tablet computer, smartwatch, etc., as well computer systems, such as a desktop computer system, laptop computer system, server computer systems, etc. The platform systems 104 and subscriber systems 108 may also be one or more computing devices, such as one or more server computer systems, desktop computer systems, etc. Furthermore, there may be any number of user systems 106 and/or subscriber systems 108 utilizing the services of the platform systems 104. However, to avoid obscuring the present description, only one platform system 104, user system 106, and subscriber system 108 are generally illustrated and described.

Furthermore, it should be appreciated that the embodiments discussed herein may be utilized by a plurality of different types of systems, such as inventory platform system(s), resource platform system(s), commerce platform system(s) including payment processing systems, card authorization systems, banks, and other systems. Furthermore, any system seeking to verify entity state-quantity values for asynchronous operations may use and/or extend the techniques discussed herein to improve efficiency, scalability, and/or availability of state-quantity value verification. However, to avoid obscuring the embodiments discussed herein, state-quantity value verification (e.g., via an entity state unifier 114), is discussed to illustrate and describe the embodiments of the present disclosure, and is not intended to limit the application of the techniques described herein to other systems in which state-quantity value verification could be used.

The platform system 104, subscriber system 108, and user system 106 may be coupled to a network 102 and communicate with one another using any of the standard protocols for the exchange of information, including secure communication protocols. In one embodiment, one or more of the platform system 104, subscriber system 108, and user system 106 may run on one Local Area Network (LAN) and may be incorporated into the same physical or logical system, or different physical or logical systems. Alternatively, the platform system 104, subscriber system 108, and user system 106 may reside on different LANs, wide area networks, cellular telephone networks, etc. that may be coupled together via the Internet but separated by firewalls, routers, and/or other network devices. In one embodiment, platform system 104 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, platform system 104 provides processing services to one or more merchants, such as to subscriber system 108 and/or user system 106 that act as an agent of subscriber system 108. For example, platform system 104 may manage merchant accounts held at the commerce platform, run transactions from user system 106 performed on behalf of a merchant, clear transactions, performing payouts to merchant and/or merchant agents, manage merchant and/or agent accounts held at the platform system 104, as well as other services typically associated with commerce platforms systems.

To verify state-quantity values, in embodiments, platform system 104 utilizes a server system 110 including one or more requestors for asynchronous operations 112 and/or an entity state unifier 114. As will be discussed in greater detail below, the entity state unifier 114 may identify requests from requestors for asynchronous operations 112 and efficiently control performance of the asynchronous operation corresponding to an entity by verifying associated with state-quantity values of an entity object in a uniform, scalable, and reliable manner. In many embodiments, the entity state unifier 114 may receive input from and communicate output to a user device 116 during verification of state-quantity values. In the illustrated embodiment, the user device 116 is included in the subscriber system 108. However, in additional, or alternative embodiment, the user device 116 may be included in user system 106 and/or platform system 104 without departing from the scope of this disclosure. In some examples, the requestors for asynchronous operations 112 and entity state unifier 114 operate substantially independently from each other. Thus, one or more embodiments described herein generally decouple requesting (or initiating) asynchronous operations on an entity (which may be performed by requestors for asynchronous operations 112) and verification of state-quantity values corresponding to the entity (which may be performed by entity state unifier 114) to provide improved performance and reliability.

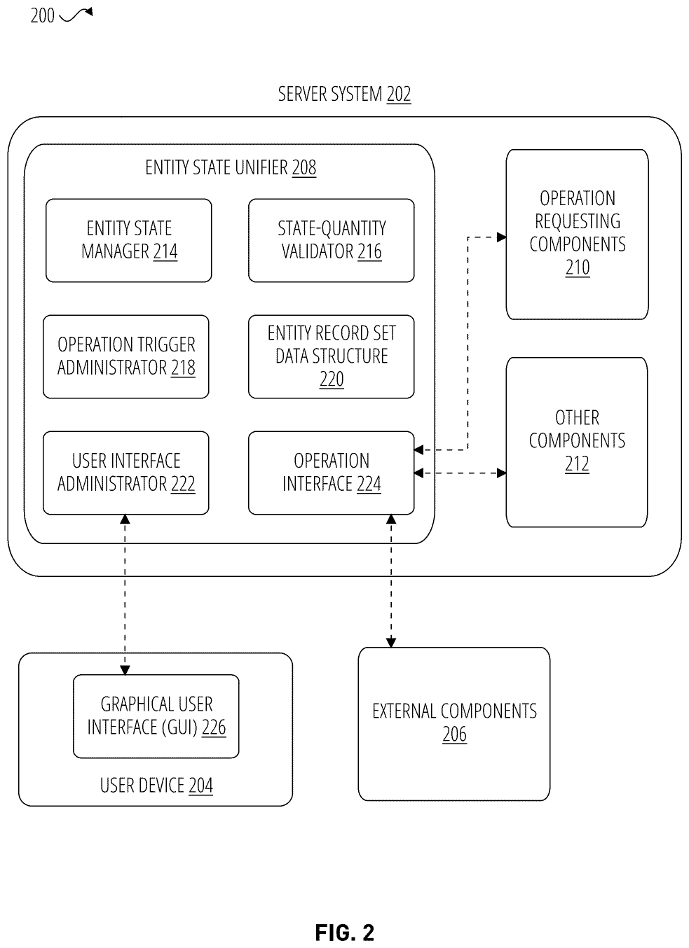

FIG. 2 illustrates an operating environment 200 for an entity state unifier 208 according to some embodiments. In various embodiments, the components of entity state unifier 208 may operate to control performance of, or perform, asynchronous operations corresponding to entities based on verification of state-quantity values stored in entity objects corresponding to the entities. It will be appreciated that one or more components of FIG. 2 may be the same or similar to one or more other components disclosed herein. For example, entity state unifier 208 may be the same or similar to entity state unifier 114. In another example, operation requesting components 210 may be the same or similar to the asynchronous operation requestors 112. Further, aspects discussed with respect to various components in FIG. 2 may be implemented by one or more other components from one or more other embodiments without departing from the scope of this disclosure. For example, entity record set data structure 220 may be implemented by components external to the entity state unifier 208 and/or server system 202 without departing from the scope of this disclosure. Embodiments are not limited in this context.

In the operating environment 200, the entity state unifier 208 is included in a server system 202. The server system 202 is communicatively coupled to a user device 204 and one or more external components 206. Further, the server system 202 includes the entity state unifier 208, one or more operation requesting components 210, and one or more other components 212. The entity state unifier 208 includes an entity state manager 214, a state-quantity validator 216, an operation trigger administrator 218, an entity record set data structure 220, a user interface administrator 222, and an operation interface 224. The user interface administrator 222 may be communicatively coupled to a graphical user interface (GUI) 226 of the user device 204. The operation interface 224 may be communicatively coupled to one or more operation requesting components 210, one or more other components 212, and/or one or more external components 206.

The entity state unifier 208 may interact with various components, such as operation requesting components 210, other components 212, and external components 206 to perform one or more operations described hereby. In many embodiments, the entity state unifier 208 may utilize operation interface 224 to interact with other components, such as to receive and/or send requests to perform one or more operations described herein. In various embodiments, the requests may be received from operation requesting components 210 and/or external components 206. In one embodiment, a request may be received via user device 204. In some embodiments, operation interface 224 may provide an application programming interface (API) for other components to interact with entity state unifier 208. Similarly, operation interface 224 may utilize one or more APIs to interact with other components. In various embodiments, the entity state unifier may provide data to various downstream components (e.g., included in external components 206 or other components 212). For example, entity objects or data from entity objects may be provided to downstream components, such as for backfilling or exports.

The entity state manager 214 may generally be responsible for creating, updating, modifying, retrieving, and maintaining entity objects corresponding to entities. In many embodiments, the entity state manager 214 may create, update, modify, retrieve, and/or maintain entity objects stored in entity record set data structure 220. The entity record set data structure 220 may provide a source of truth for verifying state-quantity values associated with entities, resulting in more reliable and trustworthy verifications. Additionally, the entity state manager 214 may utilize incoming requests to identify and/or access one or more entity objects stored in the entity record set data structure 220. For example, the entity state manager 214 may identify and/or retrieve data from an entity object corresponding to a request for an asynchronous operation received from one of the operation requesting components 210. In various embodiments, the entity state manager 214 may utilize a unique identifier included in the request to identify and/or retrieve data from an entity object stored in entity record set data structure 220.

In several embodiments, the entity state manager 214 may provide entity object data to state-quantity validator 216. In several such embodiments, the entity state manager 214 may retrieve data from an entity object and/or modify data in an entity object, such as a state-quantity value stored in entity record set data structure 220, based on a request or indication from the state-quantity validator 216. More generally, one or more operations performed on entity objects may be based on verifications performed by state-quantity validator 216. For example, as will be discussed in more detail below, the state-quantity validator 216 may determine or generate a proposed state-quantity value and an available state-quantity value in response to a request for an operation. The state-quantity validator 216 may then compare the proposed state-quantity value and the available state-quantity value based on one or more conditions to determine whether or not to allow performance of the operation to proceed. In some embodiments, entity state manager 214 may perform one or more checks prior to utilizing state-quantity validator 216. For example, entity state manager 214 may check for flags or marks associated with or included in the entity object. As discussed more below, the flags or marks may indicate that operations corresponding to the entity object should be delayed and/or prevented, such as to prevent or reduce erroneous operations.

The operation trigger administrator 218 may be responsible for triggering performance of one or more operations based on the output of state-quantity validator 216. For example, if state-quantity validator 216 determines an operation should proceed, operation trigger administrator 218 may trigger performance of that operation, such as an asynchronous operation. In some embodiments, the asynchronous operation may include, or be referred to as, communication of a request to an external component, such as an external network system to perform an operation. For example, the asynchronous operation may include a request for a card or institution network to authorize a quantity. In various embodiments, the asynchronous operation may include, or be referred to as, an operation performed by an external component, such as an external network system. For example, the asynchronous operation may include authorization of a quantity by a card or institution network.

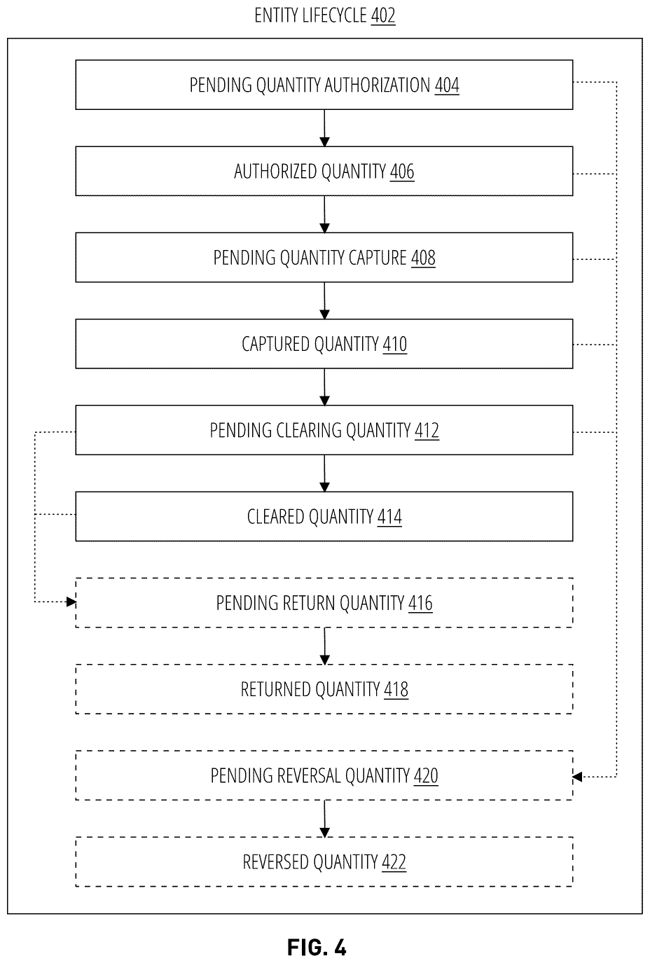

In some embodiments, the state-quantity validator 216 and/or operation trigger administrator 218 may trigger performance of an operation after expiration of a timer. For example, the request may include a timing condition. In another example, various timing conditions may be automatically utilized based on various rules. For instance, operation requests associated with a particular state or stage of a lifecycle (see e.g., FIG. 4) may be triggered after a predetermined amount of time. In another instance, operations associated with a quantity over a threshold amount may be triggered after a predetermined amount of time. In various embodiments, the timing conditions may cause operations to be performed after the likelihood of the operation being subsequently reversed is sufficiently low. For example, 80% of transaction reversals or refunds may occur within 2 hours of the transaction being initiated. Accordingly, a transaction may only be cleared after 2 hours. Accordingly, these timing conditions can reduce resource demands and improve efficiency.

In various embodiments, operation trigger administrator 218 may cause entity state manager 214 to modify one or more entity objects. In various such embodiments, the operation trigger administrator 218 may cause entity state manager 214 to flag or mark entity objects based on triggering performance of an operation. For example, operation trigger administrator 218 may cause entity state manager 214 to associate a mark or flag with entity objects. In some embodiments, individual quantities and/or state-quantity values may be separately marked. In some such embodiments, this may enable separating multiple subsequent operations resulting from the same state change.

Continuing with the previous example, when an operation is triggered, the corresponding entity object may be marked or flagged. In some embodiments, this occurs based on timing conditions. For example, separate timers may be set to trigger operations and marking/flagging. This mark or flag may serve to prevent a subsequently received operation request associated with the entity object from being performed or fully evaluated by the entity state unifier 208 between when the operation is triggered and when performance of the operation is completed. For example, the entity state manager 214 or operation interface 224 may identify the mark or flag prior to having state-quantity validator 216 evaluate a subsequent request. In some embodiments, the mark or flag may result in a message being sent to the component that sent the subsequent request to cause the component to resend the request for the subsequently received operation at a later time. In this manner, the entity state unifier 208 can prevent a subsequent operation from affecting an entity object when a current operation associated with the entity object is in progress. The mark or flag may be removed upon indication that performance, or some aspects thereof, were successful. In one example, the mark or flag may be removed in response to a failure of performance, such as in a non-retriable manner. In many embodiments, the flags may be utilized to prevent simultaneous, or substantially simultaneous, modifications to state-quantity values. For example, the flags may be utilized to prevent a race condition between different asynchronous operations.

The user interface administrator 222 may enable a user, such as a subscriber or an administrator to interact with the entity state unifier 208. For example, a user may view various entity state objects in entity record set data structure 220 via user interface administrator 222. In the illustrated embodiment, a user may interact with the user interface administrator 222 via a GUI 226 displayed on a user device 204. In various embodiments, values in an entity object, such as state-quantity values, may be modified via the GUI 226. In some embodiments, various parameters of the entity state unifier may be configured via the GUI 226, such as test conditions or timing conditions. In one embodiment, a user may utilize the user device 204 to request one or more asynchronous operations associated with an entity object. For example, a user may initiate a refund via the user device 204.

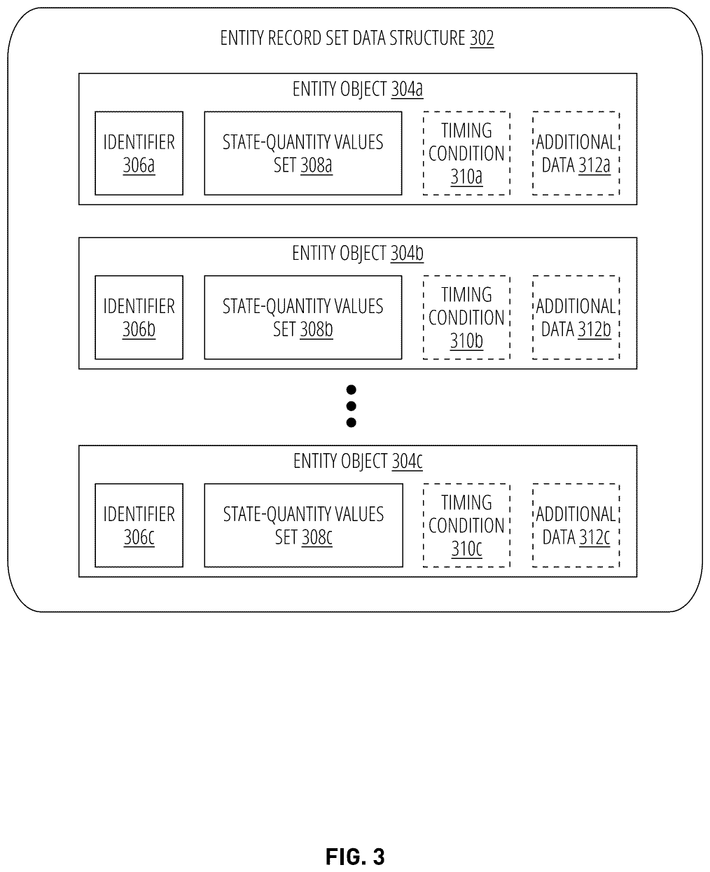

FIG. 3 illustrates various aspects of an entity record set data structure 302 according to some embodiments. The entity record set data structure 302 includes one or more entity objects 304a, 304b, 304c (collectively referred to as entity objects 304). Each of the entity objects 304 include an identifier 306a, 306b, 306c (collectively referred to as identifiers 306) and a state-quantity values set 308a, 308b, 308c (collectively referred to as state-quantity value sets 308). One or more of the entity objects 304 may additionally include a timing condition 310a, 310b, 310c (collectively referred to as timing conditions 310) and/or additional data 312a, 312b, 312c (collectively referred to as additional data 312). In various embodiments, the entity objects 304 in entity record set data structure 302 may provide the states and values associated with an entity that can be verified. It will be appreciated that one or more components of FIG. 3 may be the same or similar to one or more other components disclosed herein. For example, entity record set data structure 302 may be the same or similar to operation requesting components entity record set data structure 220. Further, aspects discussed with respect to various components in FIG. 3 may be implemented by one or more other components from one or more other embodiments without departing from the scope of this disclosure. For example, entity record set data structure 220 may be implemented by entity state unifier 114 without departing from the scope of this disclosure. Embodiments are not limited in this context.

In various embodiments, each of the one or more entity objects 304 may correspond to an entity, such as a product order. The entity objects 304 may be utilized to track state-quantity values for the corresponding entity. In many embodiments, each entity may have a lifecycle with a plurality of stages (see e.g., FIG. 4) and one or more of the stages may, at least at some point in the lifecycle of the entity, have a state-quantity value in the state-quantity value set 308 associated with it. In several embodiments, a state-quantity value may be a key-value pair.

Additionally, the timing conditions 310 may relate to delays for triggering various entity related operations. The additional data 312 may correspond to various other data regarding or corresponding to an entity object. For example, the additional data 312 may include a log of previous requests, verifications, and the like for an entity object. In one example, the additional data 312 may include an action or type of action to be executed when the timing condition is satisfied. In some embodiments, the additional data 312 may include a flag or mark, as discussed above. In these and other ways, the entity record set data structure 302 may provide a source of truth for verifying state-quantity values, triggering asynchronous operations, and tracking status of entities, resulting in more reliable and trustworthy operations with fewer errors (e.g., conflicting values).

FIG. 4 illustrates various aspects of an entity lifecycle 402 according to some embodiments. The entity lifecycle 402 includes various states or stages that are possible during the use of an entity object corresponding to an entity. For example, the entity may include a transaction for goods or services and the various states in the entity lifecycle 402 may correspond to a quantity exchanged for the goods or services. In the illustrated embodiment, the entity lifecycle 402 includes pending quantity authorization 404, authorized quantity 406, pending quantity capture 408, captured quantity 410, pending clearing quantity 412, cleared quantity 414, pending return quantity 416, returned quantity 418, pending reversal quantity 420, and reversed quantity 422. It will be appreciated that life entity lifecycle 402 is exemplary, and a modified, or alternative, entity lifecycle 402 may be utilized without departing from the scope of this disclosure. In one or more embodiment disclosed hereby, the various states of entity lifecycle 402 encountered by an entity may have a corresponding state-quantity value included in the corresponding entity object. Further, techniques disclosed hereby may verify states, quantities, and/or conditions prior to allowing operations that modify states and/or quantities. Embodiments are not limited in this context.

An exemplary object may progress through the various stages of the entity lifecycle 402. In various embodiments, a state-quantity value may be generated and/or populated in an entity object for each stage that occurs to the corresponding entity. Further, various delays, such as based on timing conditions and processing delays, may occur between different stages. In many embodiments, the pending stages may, at least partially, be due to the delays between different stages. Additionally, or alternatively, pending stages may serve to reserve quantities from previous stages such that the reserved quantity can't be acted upon by a competing user system (e.g., in a race).

In some embodiments, the stages of the entity lifecycle 402 may correspond to different stages in processing a payment card transaction. For example, the pending quantity authorization 404 may correspond to a quantity set prior to an authorization request being made to the card network. The authorized quantity 406 may correspond to a quantity set based on a card network response to an authorization request. The pending quantity capture 408 may correspond to a quantity needed to be authorized that is set to be captured. The captured quantity 410 may correspond to a quantity captured, such as by a merchant, to be cleared. For example, a quantity may initially be authorized in order to act as a confirmation that the quantity will be available when a service is performed (e.g., a hold placed on funds) and the quantity may only be captured once the service is actually performed. The pending clearing quantity 412 may correspond to a quantity that has been captured but not sent to clearing yet. The cleared quantity 414 may correspond to a quantity that has been sent to clearing.

The remaining stages of entity lifecycle 402 may correspond to operations that return some quantity to a customer or client. The pending return quantity 416 may correspond to a quantity that should be reduced from the captured or cleared amount. The returned quantity 418 may correspond to an amount that has been successfully refunded. The pending reversal quantity 420 may correspond to an amount that is pending to be reversed from the card network. The reversed quantity 422 may correspond to an amount successfully reversed. The reversal quantities may result in lower processing fees, but may only be performed prior to a quantity being captured. The return, or refund, quantities may incur high processing fees, but be required once a quantity has been cleared.

In some embodiments, only a portion of the state-quantity values may be visible to some users, such as user device 116. For example, pending quantities may not be user facing. More generally, various portions of the data included in an entity object may not be user facing. For example, timing conditions or logs may not be user facing. Some embodiments may include user accounts with differing privileges. For example, administrators may be able to access all data while subscriber clients are restricted from non-user facing data.

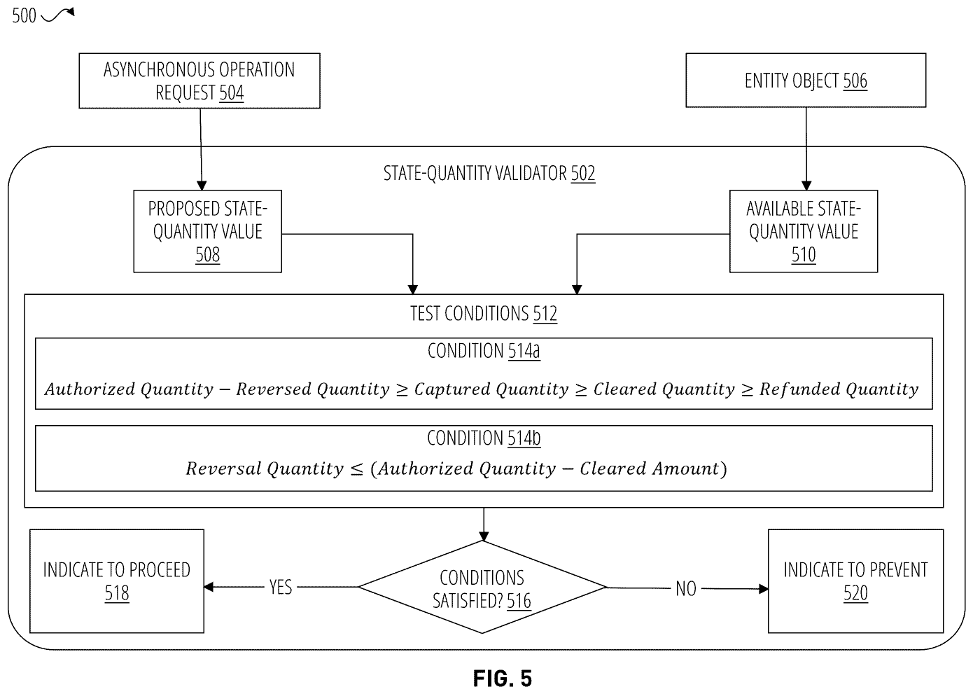

FIG. 5 illustrates a process flow 500 for a state-quantity validator 502 according to some embodiments. For example, process flow 500 may support controlling an asynchronous operation in response to a comparison of a proposed state-quantity value 508 and an available state-quantity value 510. More generally, the process flow 500 may illustrate an exemplary operation to verify state-quantity values for asynchronous operations in a reliable and efficient manner. The illustrated components of FIG. 5 include the state-quantity validator 502, an asynchronous operation request 504, and an entity object 506. One or more components of FIGS. 5A-5C may be the same or similar to one or more other components disclosed hereby. For example, state-quantity validator 502 may be the same or similar to state-quantity validator 216. Further, aspects discussed with respect to various components in FIG. 5 may be implemented by one or more other components from one or more other embodiments without departing from the scope of this disclosure. For example, one or more aspects of process flow 500 may be implemented by other components of entity state unifier 208 or server system 202 without departing from the scope of this disclosure. Embodiments are not limited in this context.

Referring to FIG. 5, process flow 500 may begin with an asynchronous operation request 504 and/or data indicative of the asynchronous operation request being received by the state-quantity validator 502. The asynchronous operation request 504 may be utilized to determine a proposed state-quantity value 508. The proposed state-quantity value 508 may be utilized by the state-quantity validator 502 to compare against the available state-quantity value 510. In one example, the asynchronous operation request 504 may correspond to initiation of a reversal prior to an entity entering the captured quantity stage of the lifecycle, such as the authorized quantity stage. Accordingly, performance of the operation associated with the asynchronous operation request 504 may result in initiation of a quantity reversal operation and a transition of the entity corresponding to entity object 506 into a pending reversal quantity state

In various embodiments, the state-quantity validator 502 may identify and retrieve data corresponding to entity object 506, such as from an entity record set data structure. In various such embodiments, the state-quantity validator 502 may identify and/or retrieve the data based on data included in the asynchronous operation request 504, such as a unique identifier.

Referring back to process flow 500, the available state-quantity value 510 may be generated based on data from entity object 506. For example, the available state-quantity value 510 may include the authorized-quantity value from entity object 506. In many embodiments, the available state-quantity value 510 may include multiple state-quantity values. In several embodiments, the available state-quantity value 510 may be derived, calculated, or generated based on one or more state-quantity values in entity object 506. In some embodiments, one or more proposed state-quantity values may be derived, calculated, or generated based on the asynchronous operation request 504 and/or test conditions 512.

The proposed state-quantity value 508 and the available state-quantity value 510 may be compared based on one or more test conditions 512. These test conditions 512 may be utilized to perform a variety of checks on the proposed state-quantity value 508. The illustrated embodiment includes a first condition 514a and a second condition 514b. However, it will be appreciated that more or less conditions may be utilized. For example, a condition may include determining whether the proposed state-quantity value 508 matches a corresponding state-quantity value of entity object 506.

Additionally, various conditions and/or portions of conditions may be utilized in comparisons. For example, if entity object 506 does not include a state-quantity value or a null or zero value, portions of a condition that apply to that state-quantity value would not be applied or relied upon. Further, different ones of proposed state-quantity value 508 and/or available state-quantity value 510 may be utilized with respect to different conditions.

Further, in various embodiments, test conditions 512 may be selected based on data, such as data included in asynchronous operation request 504, entity object 506, and/or proposed state-quantity value 508. For example, the state of the proposed state-quantity value 508 may determine, at least in part, which conditions, or portions thereof, are applied. In some embodiments, test conditions or test condition identifiers may be included in the additional data of entity objects. Further conditions may be combined, such as via Boolean logic. In one embodiment, a satisfaction score may be determined based on one or more comparison operations performed between available state-quantity value 510.

Based on the comparisons performed on the proposed state-quantity value 508 and available state-quantity value 510, the state-quantity validator 502 may determine whether the conditions were satisfied at decision block 516. If the conditions were satisfied, the state-quantity validator 502 may indicate to proceed 518 with performance of the operation. However, if the conditions were not satisfied, the state-quantity validator 502 may indicate to prevent 520 performance of the operation.

Additional operations may occur prior to, within, or in response to process flow 500. For example, an indication to proceed may result in performance of the corresponding operation (e.g., transmitting a request to a card or bank network). In various embodiments, the indication to proceed or prevent performance of the asynchronous operation may be passed to operation trigger administrator 218 and/or entity state manager 214. In various such embodiments, the operation trigger administrator 218 may trigger the corresponding operation, such as a refund request sent to a card network. In an additional example, the entity object 506 may be updated or modified, such as by adding a state-quantity value (e.g., the proposed state-quantity value 508). In yet another example, indicate to prevent 520 may result in responses being sent to the requestor for the operation. In some embodiments, indicate to prevent 520 may trigger further review of the entity, such as in other enterprise systems. In one embodiment, indicate to prevent 520 may trigger a manual review of the entity. Additionally, or alternatively, the indicate to prevent 520 may trigger a user facing notification, such as via user device 204 and/or GUI 226. In these and other ways, the state-quantity validator 502 may provide efficient, adaptable, and dynamic verifications corresponding to asynchronous operations in a scalable manner.

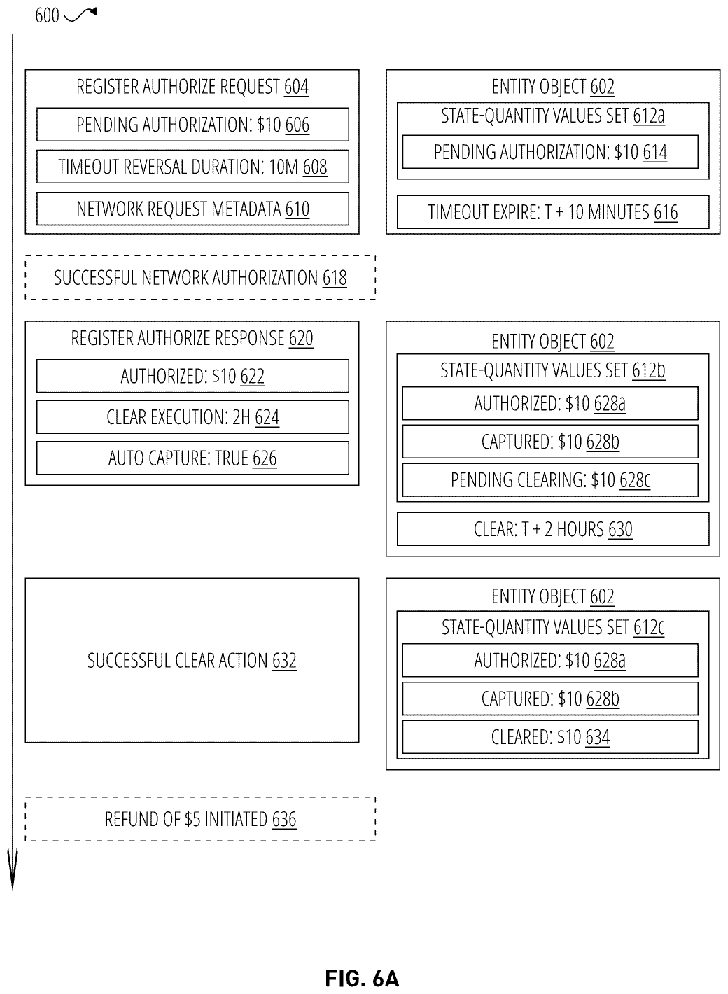

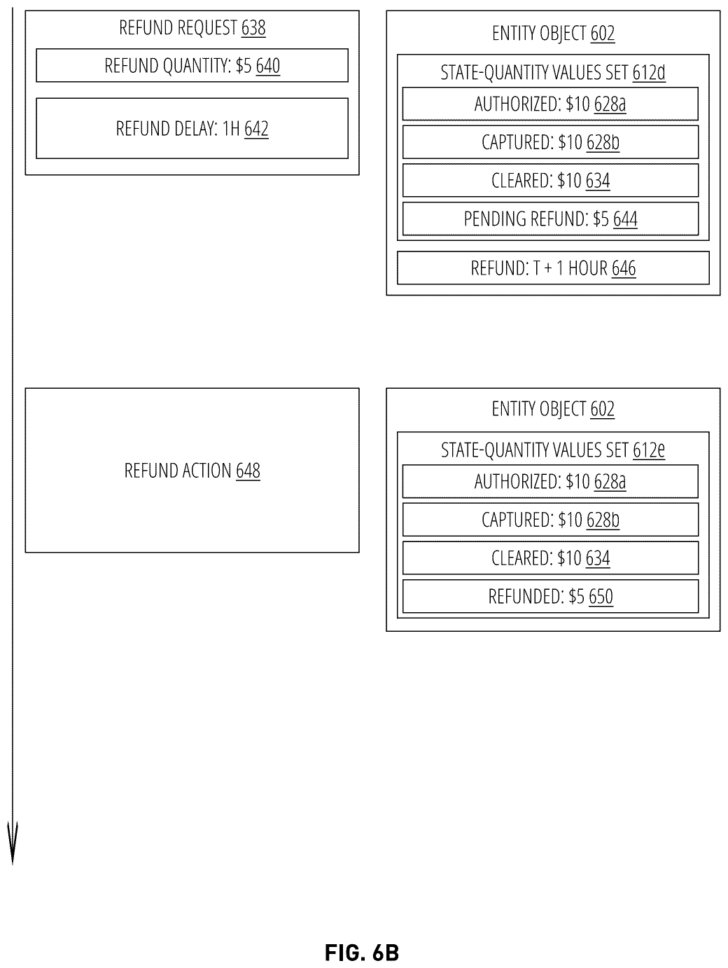

FIGS. 6A and 6B illustrate a process flow 600 for an entity object 602 according to some embodiments. For example, process flow 600 may illustrate exemplary aspects of the entity object 602 as it progresses through various states and quantities during a lifecycle of a corresponding entity. Generally, the components on the left side of FIGS. 6A and 6B correspond to operations associated with the entity and the components of the right side correspond to contents of the entity object 602 as the operations are requested and/or performed. Many aspects of process flow 600 will be described with respect to one or more components of operating environment 200, such as entity state unifier 208. One or more components of FIGS. 6A and 6B may be the same or similar to one or more other components disclosed hereby. For example, entity object 602 may be the same or similar to entity object 304a. Embodiments are not limited in this context.

Referring to FIG. 6A, process flow 600 may begin with a block 604. At block 604 a register authorize request including a proposed state-quantity value 606, a proposed timing condition 608, and additional data 610 may be identified, such as by an entity state unifier. The proposed state-quantity value 606 includes a proposed state for entity object 602 of pending authorization and a corresponding quantity of 10. The proposed timing condition 608 may include a timeout reversal duration of 10 minutes. The additional data 610 may include data associated with performance of the operation of block 604. For example, the corresponding authorize request may be transmitted to external components, such as an external network (e.g., a card network) and the additional data 610 may cause metadata to be requested from the external network.

Based on the register authorize request, entity object 602 may be created and/or modified to include a state-quantity values set 612a with a state-quantity value 614 of pending authorization state and a quantity of 10. Additionally, a timing condition 616 may be included. The timing condition 616 may trigger performance of the authorize request operation at the end of the timing condition 616 (e.g., after 10 minutes). Alternatively, the timeout expiry is only triggered if an authorize response is not registered within the 10 minutes to update the entity, thus the request is sent before 10 minutes (e.g., a predetermined amount of time prior to expiration). Otherwise, the timeout expiry would add a reversal and undo the pending authorization. Additionally, the entity object 602 may be temporarily flagged after expiration of the time until a release indication (e.g., successful performance message). In some embodiments, no comparisons may be performed based on the register authorize request because it is the first stage in the lifecycle of the entity. In the scenario of process flow 600, the entity may be a payment card transaction, such as one submitted by a subscriber in response to a customer purchase.

After 10 minutes (or a predetermined amount of time before 10 minutes), the authorize request may be transmitted and at block 618, the successful network authorization may occur (prior to 10 minutes having elapsed). In some embodiments, the register authorize response at block 620 may be identified by the entity state unifier. Although not separately illustrated, in some embodiments, the entity object 602 may be updated based on the successful network authorization prior to the quantity is captured. For example, in the register authorize response, the additional data 626 may indicate that auto capture is true. Accordingly, authorization and capture may occur at the same time or substantially the same time (e.g., sequentially with little or no delay in between).

In various embodiments, the entity object 602 may be utilized to verify the proposed state-quantity value 622 of block 620. For example, the proposed state-quantity value 622 may be verified against the pending authorization state-quantity value 614. As described in more detail above, additionally, or alternatively, one or more comparisons may be performed based on various test conditions. Successful satisfaction of the associated conditions result in the entity object 602 including a state-quantity values set 612b including state-quantity value 628a having an authorized quantity of 10, state-quantity value 628b having a captured quantity of 10, and state-quantity value 628c having a pending clearing quantity of 10. Additionally, entity object 602 may include a timing condition 630 that causes the clearing operation to be performed in two hours. Accordingly, at block 632 a successful clearing action may be determined. In response, entity object 602 may be updated to include state-quantity value 634 having a cleared quantity of 10 in place of the state-quantity value 628c. Subsequently, a refund may be initiated in process flow 600 at block 636.

Referring to FIG. 6B, a refund request may be identified at block 638 of process flow 600. The refund request may include a proposed state-quantity value 640 having a refund quantity of 5 and a timing condition 642 indicating a one hour delay. In response, the entity object 602 may be updated to include a state-quantity value 644 having a pending refund quantity of 5 and the timing condition 646 with the one hour delay. The timing conditions may be utilized to implement one or more timers or counters, such as by/for the operation trigger administrator or entity state manager. Flag times may additionally be set. At the end of the hour, the refund action may be performed and/or notification of its performance may be received at block 648. Accordingly, entity object 602 may be updated to include a state-quantity value 650 having a refunded quantity of 5 in place of the state-quantity value 644. By continually updating the contents of entity object 602 throughout the lifecycle of the corresponding entity, improved visibility regarding status and current details of an entity is realized. Further, the improved visibility can make diagnosing and correcting issues simpler and more efficient.

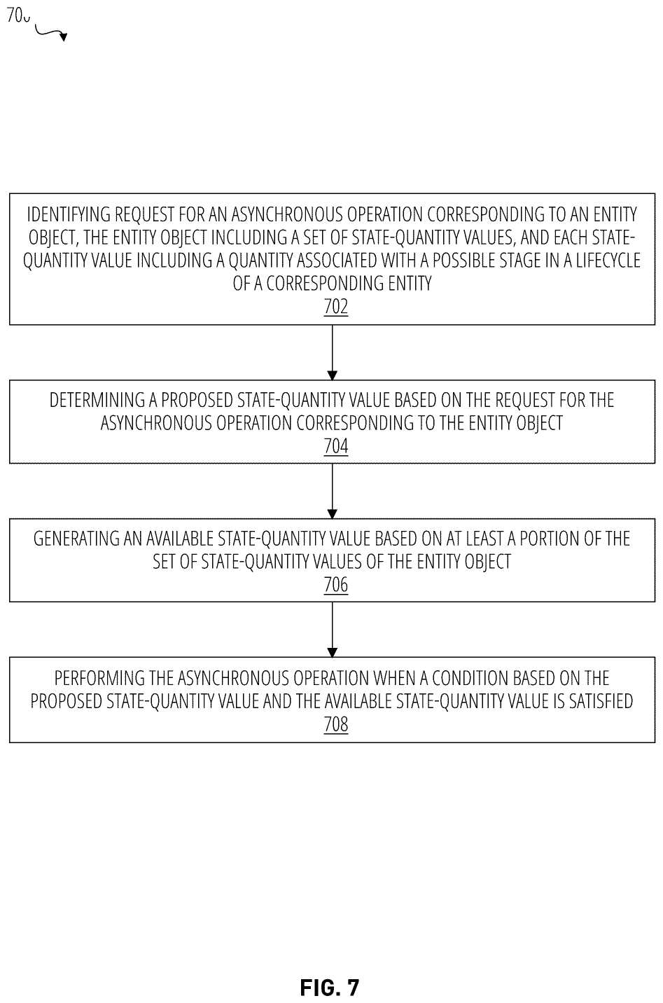

FIG. 7 illustrates a logic flow 700 of a method for controlling performance of asynchronous operations according to some embodiments. The logic flow 700 is performed by processing logic that may comprise hardware (circuitry, dedicated logic, etc.), software (such as is run on a general purpose computer system or a dedicated machine), firmware, or a combination. In various embodiments, the logic flow 700 is performed by one or more of a platform system (e.g., platform system 104), a server system (e.g., server system 110 or server system 202), and an entity state unifier (e.g., entity state unifier 208). Embodiments are not limited in this context.

Referring to FIG. 7, the logic flow 700 begins at block 702. At block 702, a request for an asynchronous operation corresponding to an entity object may be identified. The entity object may include a set of state-quantity values and each state-quantity value may include a quantity associated with a possible stage in a lifecycle of the corresponding entity. For example, a request for an asynchronous operation corresponding to entity object 304b may be received by entity state unifier 208. In some embodiments, the entity object 304b may be identified as corresponding to the asynchronous operation based on the identifier 306b. Further, the entity object 304b may include a state-quantity values set 308b and each state-quantity value in state-quantity values set 308b may be associated with one of the possible stages in entity lifecycle 402.

Proceeding to block 704, a proposed state-quantity value may be determined based on the request for the asynchronous operation corresponding to the entity object. For example, state-quantity validator 502 may determine proposed state-quantity value 508 based on the asynchronous operation request 504. Continuing to block 706, an available state-quantity value may be generated based on at least a portion of the set of state-quantity values of the entity object. For example, state-quantity validator 502 may generate an available state-quantity value 510 based on at least a portion of the set of state-quantity values of entity object 506. In various embodiments, the available state-quantity value 510 may be additionally determined based on one or more of the asynchronous operation request 504, the proposed state-quantity value 508, and/or test conditions 512.

At block 708, the asynchronous operation may be performed when a condition based on the proposed state-quantity value and the available state-quantity value is satisfied. For example, a comparison of the proposed state-quantity value 508 and the available state-quantity value 510 may be performed by state-quantity validator 502 based on one of test conditions 512 and when the test condition is satisfied the asynchronous operation may be performed. For instance, a request to authorize or clear the proposed state-quantity value may be communicated. In some embodiments, it may alternatively be determined that the condition can never be satisfied and the asynchronous operation may be abandoned.

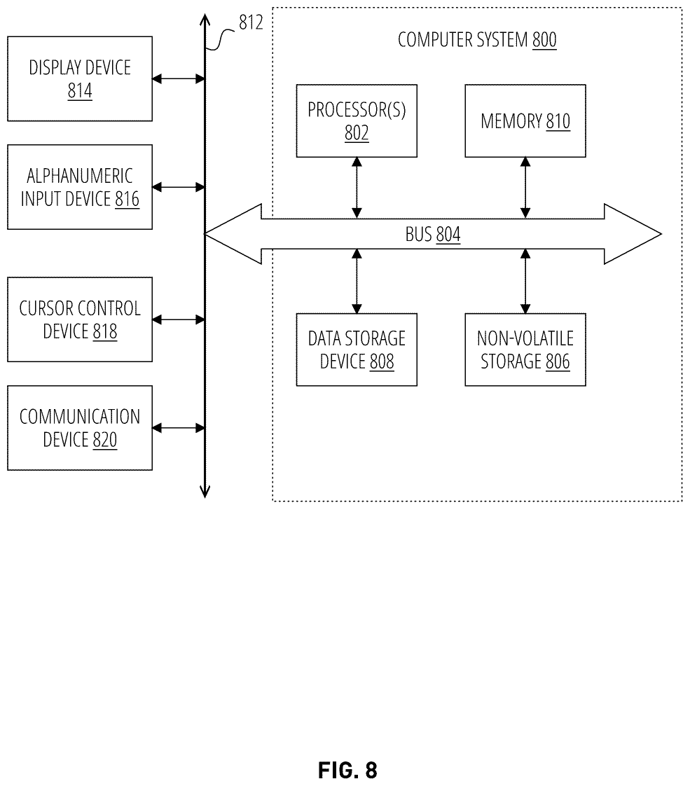

FIG. 8 is one embodiment of a computer system 800 that may be used to support the systems and operations discussed herein. For example, the computer system illustrated in FIG. 8 may be used by a platform system, a server system, a user system, an entity state unifier, one or more components thereof, etc. It will be apparent to those of ordinary skill in the art, however that other alternative systems of various system architectures may also be used.

The data processing system illustrated in FIG. 8 includes a bus or other internal communication means 804 for communicating information, and one or more processors 802 coupled to the bus 804 for processing information. The system further comprises a random access memory (RAM) or other volatile storage device (referred to as memory 810), coupled to bus 804 for storing information and instructions to be executed by processor 802. Memory 810 (e.g., main memory) also may be used for storing temporary variables or other intermediate information during execution of instructions by processor 802. The system also comprises non-volatile storage 806 (e.g., read only memory (ROM) and/or static storage device) coupled to bus 804 for storing static information and instructions for processor 802, and a data storage device 808 such as a magnetic disk or optical disk and its corresponding disk drive. Data storage device 808 is coupled to bus 804 for storing information and instructions.

The system may further be coupled to a display device 814, such as a light emitting diode (LED) display or a liquid crystal display (LCD) coupled to bus 804 through bus 812 for displaying information to a computer user. An alphanumeric input device 816, including alphanumeric and other keys, may also be coupled to bus 804 through bus 812 for communicating information and command selections to processor 802. An additional user input device is cursor control device 818, such as a touchpad, mouse, a trackball, stylus, or cursor direction keys coupled to bus 804 through bus 812 for communicating direction information and command selections to processor 802, and for controlling cursor movement on display device 814.

Another device, which may optionally be coupled to computer system 800, is a communication device 820 for accessing other nodes of a distributed system via a network. The communication device 820 may include any of a number of commercially available networking peripheral devices such as those used for coupling to an Ethernet, token ring, Internet, or wide area network. The communication device 820 may further be a null-modem connection, or any other mechanism that provides connectivity between the computer system 800 and the outside world. Note that any or all of the components of this system illustrated in FIG. 8 and associated hardware may be used in various embodiments as discussed herein.

It will be appreciated by those of ordinary skill in the art that any configuration of the system may be used for various purposes according to the particular implementation. The control logic or software implementing the described embodiments can be stored in memory 810 (e.g., main memory), data storage device 808 (e.g., mass storage device), non-volatile storage 806 (e.g., ROM), or other storage medium locally or remotely accessible to processor 802.

It will be apparent to those of ordinary skill in the art that the system, method, and process described herein can be implemented as software stored in memory 810, non-volatile storage 806, and/or data storage device 808 and executed by processor 802. This control logic or software may also be resident on an article of manufacture comprising a computer readable medium having computer readable program code embodied therein and being readable by the data storage device 808 and for causing the processor 802 to operate in accordance with the methods and teachings herein.

The embodiments discussed herein may also be embodied in a handheld or portable device containing a subset of the computer hardware components described above. For example, the handheld device may be configured to contain only the bus 804, the processor 802, and memory 810 and/or non-volatile storage 806. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 802, a data storage device 808, a bus 804, and memory 810, and only rudimentary communications mechanisms, such as a small touchscreen that permits the user to communicate in a basic manner with the device. In general, the more special purpose the device is, the fewer of the elements need be present for the device to function.

There are a number of example embodiments described herein.

Example 1 is a method comprising: identifying a request for an asynchronous operation corresponding to an entity object, the entity object including a set of state-quantity values, and each state-quantity value including a quantity associated with a possible stage in a lifecycle of a corresponding entity; determining a proposed state-quantity value based on the request for the asynchronous operation corresponding to the entity object; generating an available state-quantity value based on at least a portion of the set of state-quantity values of the entity object; and performing the asynchronous operation when a condition based on the proposed state-quantity value and the available state-quantity value is satisfied.

Example 2 is the method of Example 1 that may optionally include that the condition is satisfied when the proposed state-quantity value is less than or equal to the available state-quantity value.

Example 3 is the method of Example 2 that may optionally include that the proposed state-quantity value includes a reversal quantity and the available state-quantity value includes an authorized quantity minus a cleared quantity.

Example 4 is the method of Example 3 that may optionally include blocking performance of the asynchronous operation when the condition is not satisfied when the proposed state-quantity value is larger than the available state-quantity value.

Example 5 is the method of Example 1 that may optionally include identifying a proposed timing condition associated with the asynchronous operation; updating the entity object to include a timing condition corresponding to the proposed timing condition, and a pending state-quantity value corresponding to the proposed state-quantity value and associated with a particular stage in the lifecycle of the corresponding entity; and performing the asynchronous operation when the proposed timing condition based on the proposed state-quantity value and the available state-quantity value is satisfied is satisfied.

Example 6 is the method of Example 5 that may optionally include determining performance of the asynchronous operation was successful; and updating the entity object to include a non-pending state-quantity value corresponding to the proposed state-quantity value and associated with the particular stage in the lifecycle of the corresponding entity in response to determining performance of the asynchronous operation was successful.

Example 7 is the method of Example 5 that may optionally include that the request for the asynchronous operation includes a first request for a first asynchronous operation, and that may optionally include performing the first asynchronous operation when the proposed timing condition is satisfied; receiving a second request for a second asynchronous operation corresponding to the entity object prior to a determination the first asynchronous operation was successful; and responding to the second request by requesting the second request be resubmitted.

Example 8 is the method of Example 5, that may optionally include that the request for the asynchronous operation includes a first request for a first asynchronous operation, and that may optionally include receiving a second request for a second asynchronous operation corresponding to the entity object prior to the proposed timing condition being satisfied; and canceling the timer configured to trigger performance of the first asynchronous operation based on the second asynchronous operation.

Example 9 is a server computer system comprising a memory and a processor coupled to the memory configured to perform the method of any of Examples 1 to 8.

Example 10 is a non-transitory machine-readable medium having executable instructions to cause one or more processing units to perform the computer-implemented method of any of Examples 1 to 8.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A method comprising:
identifying a request for an asynchronous operation corresponding to an entity object, the entity object including a set of state-quantity values, and each state-quantity value including a quantity associated with a possible stage in a lifecycle of a corresponding entity;
determining a proposed state-quantity value based on the request for the asynchronous operation corresponding to the entity object;
generating an available state-quantity value based on at least a portion of the set of state-quantity values of the entity object; and
performing the asynchronous operation when a condition based on the proposed state-quantity value and the available state-quantity value is satisfied.

2. The method of claim 1, wherein the condition is satisfied when the proposed state-quantity value is less than or equal to the available state-quantity value.

3. The method of claim 2, wherein the proposed state-quantity value includes a reversal quantity and the available state-quantity value includes an authorized quantity minus a cleared quantity.

4. The method of claim 1, further comprising blocking performance of the asynchronous operation when the condition is not satisfied when the proposed state-quantity value is larger than the available state-quantity value.

5. The method of claim 1, further comprising:
identifying a proposed timing condition associated with the asynchronous operation;
updating the entity object to include a timing condition corresponding to the proposed timing condition, and a pending state-quantity value corresponding to the proposed state-quantity value and associated with a particular stage in the lifecycle of the corresponding entity; and
performing the asynchronous operation when the proposed timing condition based on the proposed state-quantity value and the available state-quantity value is satisfied.

6. The method of claim 5, further comprising:
determining performance of the asynchronous operation was successful; and
updating the entity object to include a non-pending state-quantity value corresponding to the proposed state-quantity value and associated with the particular stage in the lifecycle of the corresponding entity in response to determining performance of the asynchronous operation was successful.

7. The method of claim 5, wherein the request for the asynchronous operation includes a first request for a first asynchronous operation, and the method further comprising:
performing the first asynchronous operation when the proposed timing condition is satisfied;
receiving a second request for a second asynchronous operation corresponding to the entity object prior to a determination the first asynchronous operation was successful; and
responding to the second request by requesting the second request be resubmitted.

8. The method of claim 5, wherein the request for the asynchronous operation includes a first request for a first asynchronous operation, and the method further comprising:
receiving a second request for a second asynchronous operation corresponding to the entity object prior to the proposed timing condition being satisfied; and
canceling the timer configured to trigger performance of the first asynchronous operation based on the second asynchronous operation.

9. A non-transitory computer readable storage medium including instructions that, when executed by a processor, cause the processor to perform operations, the operations comprising:
identifying, by a server system, a request for an asynchronous operation corresponding to an entity object, the entity object including a set of state-quantity values, and each state-quantity value including a quantity associated with a possible stage in a lifecycle of a corresponding entity;
determining, by the server system, a proposed state-quantity value based on the request for the asynchronous operation corresponding to the entity object;
generating, by the server system, an available state-quantity value based on at least a portion of the set of state-quantity values of the entity object; and
performing, by the server system, the asynchronous operation when a condition based on the proposed state-quantity value and the available state-quantity value is satisfied.

10. The non-transitory computer readable storage medium of claim 9, the operations further comprising blocking performance of the asynchronous operation when the condition is not satisfied when the proposed state-quantity value is larger than the available state-quantity value.

11. The non-transitory computer readable storage medium of claim 10, the operations further comprising:
identifying a proposed timing condition associated with the asynchronous operation;
updating the entity object to include a timing condition corresponding to the proposed timing condition, and a pending state-quantity value corresponding to the proposed state-quantity value and associated with a particular stage in the lifecycle of the corresponding entity; and
performing the asynchronous operation when the proposed timing condition based on the proposed state-quantity value and the available state-quantity value is satisfied.

12. The non-transitory computer readable storage medium of claim 11, the operations further comprising:
determining performance of the asynchronous operation was successful; and
updating the entity object to include a non-pending state-quantity value corresponding to the proposed state-quantity value and associated with the particular stage in the lifecycle of the corresponding entity in response to determining performance of the asynchronous operation was successful.

13. The non-transitory computer readable storage medium of claim 11, wherein the request for the asynchronous operation includes a first request for a first asynchronous operation, and the operations further comprising:
performing the first asynchronous operation when the proposed timing condition is satisfied;
receiving a second request for a second asynchronous operation corresponding to the entity object prior to a determination the first asynchronous operation was successful; and
responding to the second request by requesting the second request be resubmitted.

14. The non-transitory computer readable storage medium of claim 11, wherein the request for the asynchronous operation includes a first request for a first asynchronous operation, and the operations further comprising:
receiving a second request for a second asynchronous operation corresponding to the entity object prior to the proposed timing condition being satisfied; and
canceling a timer configured to trigger performance of the first asynchronous operation based on the second asynchronous operation.

15. A server computer system, comprising:
a memory; and
a processor coupled to the memory configured to:
identify a request for an asynchronous operation corresponding to an entity object, the entity object including a set of state-quantity values, and each state-quantity value including a quantity associated with a possible stage in a lifecycle of a corresponding entity;
determine a proposed state-quantity value based on the request for the asynchronous operation corresponding to the entity object;
generate an available state-quantity value based on at least a portion of the set of state-quantity values of the entity object; and
performing the asynchronous operation when a condition based on the proposed state-quantity value and the available state-quantity value is satisfied.

16. The server computer system of claim 15, wherein the processor coupled to the memory is further configured to:
identify a proposed timing condition associated with the asynchronous operation;
update the entity object to include a timing condition corresponding to the proposed timing condition, and a pending state-quantity value corresponding to the proposed state-quantity value and associated with a particular stage in the lifecycle of the corresponding entity; and
perform the asynchronous operation when the proposed timing condition based on the proposed state-quantity value and the available state-quantity value is satisfied.

17. The server computer system of claim 16, wherein the processor coupled to the memory is further configured to:
determine performance of the asynchronous operation was successful; and
update the entity object to include a non-pending state-quantity value corresponding to the proposed state-quantity value and associated with the particular stage in the lifecycle of the corresponding entity in response to determining performance of the asynchronous operation was successful.

18. The server computer system of claim 16, wherein the request for the asynchronous operation includes a first request for a first asynchronous operation, and the processor coupled to the memory is further configured to:
perform the first asynchronous operation when the proposed timing condition is satisfied;
receive a second request for a second asynchronous operation corresponding to the entity object prior to a determination the first asynchronous operation was successful; and
respond to the second request by requesting the second request be resubmitted.

19. The server computer system of claim 16, wherein the request for the asynchronous operation includes a first request for a first asynchronous operation, and the processor coupled to the memory is further configured to:
receive a second request for a second asynchronous operation corresponding to the entity object prior to the proposed timing condition being satisfied; and
cancel a timer configured to trigger performance of the first asynchronous operation based on the second asynchronous operation.

20. The server computer system of claim 15, the processor coupled to the memory is further configured to block performance of the asynchronous operation when the condition is not satisfied when the proposed state-quantity value is larger than the available state-quantity value.
